(19) United States
(12) Patent Application Publication
(10) Pub. No.: US 2018/0040417 A1
(43) Pub. Date: Feb. 8, 2018

(54) INDUCTION CHARGING DEVICE

(71) Applicant: Robert Bosch GmbH, Stuttgart (DE)

(72) Inventors: Dragan Krupezevic, Stuttgart (DE); Guenter Lohr, Leinfelden-Echterdingen (DE); Juergen Mack, Goeppingen (DE); Marcin Rejman, Waiblingen (DE); Martin Gonda, Buhl (DE)

(21) Appl. No.: 15/659,269

(22) Filed: Jul. 25, 2017

(30) Foreign Application Priority Data
Aug. 5, 2016 (DE) 102016214515.0

(51) Int. Cl. H01F 38/14; H02J 50/10; H01M 10/44; H02J 7/02; H01F 27/28; H01F 27/36

(52) U.S. Cl. CPC H01F 38/14; H01F 27/288; H01F 27/365; H01M 10/44; H02J 7/025; H02J 50/10

(57) ABSTRACT

An induction charging device, in particular, a hand-held power tool induction charging device, including a coil unit and at least one shielding unit, which is for at least partially shielding the coil unit. It is provided that the induction charging device includes at least one adjustment unit, with the aid of which at least one shielding parameter of the at least one shielding unit is changeable.

### RELATED APPLICATION INFORMATION

The present application claims priority to and the benefit of German patent application no. 10 2016 214 515.0, which was filed in Germany on Aug. 5, 2016, the disclosure which is incorporated herein by reference.

### FIELD OF THE INVENTION

The present invention relates to an induction charging device, in particular, a hand-held power tool induction charging device, including a coil unit and including at least one shielding unit.

### BACKGROUND INFORMATION

An induction charging device, in particular, a hand-held power tool induction charging device, including a coil unit and including at least one shielding unit, which is provided for at least partially shielding the coil unit, is discussed in DE 10 2014 217 272 A1.

### SUMMARY OF THE INVENTION

The present invention is directed to an induction charging device, in particular, a hand-held power tool induction charging device, including a coil unit and at least one shielding unit, which is provided for at least partially shielding the coil unit.

It is provided that the induction charging device includes at least one adjustment unit, with the aid of which at least one shielding parameter of the at least one shielding unit is changeable. The coil unit may include, in particular, at least one core element and at least one induction coil. The shielding unit may be provided, in particular, in order to reduce electromagnetic disturbances.

An “induction charging device” in this context is intended to mean, in particular, a unit for charging the at least one induction rechargeable battery, which is provided for transmitting a charge current at least partially by electromagnetic conduction to the induction rechargeable battery in at least one charge state. A “coil unit” in this context is intended to mean, in particular, a unit, which includes at least one induction coil having at least one winding made of an electrically conductive material, which is provided, in at least one charge state, for generating a magnetic field via an applied electrical energy, in particular, via an AC voltage, which generates an electrical alternating current in an induction coil of the induction rechargeable battery. The coil unit, in particular, which may be the induction coil, is provided for converting an electromagnetic alternating field into an electrical alternating current and/or vice versa. The alternating field has a frequency, which may be 10 kHz-500 kHz, particularly which may be 100 kHz-120 kHz. The direction is configured, in particular, perpendicular to the coil plane in parallel to a winding axis of the induction coil. The coil unit may also include the at least one core element for increasing an inductance of the at least one induction coil.

In addition, a “shielding unit” in this context is intended to mean, in particular, a unit, which is provided for at least partially shielding the coil unit. A shielding unit may be intended to mean, in particular, one which is provided for shielding the coil unit from electromagnetic disturbances. The unit is provided, in particular, for at least reducing electromagnetic disturbances to the coil unit. The unit may include at least one electrically conductive element, in particular, a shielding element, which at least partially delimits and/or at least partially covers the coil unit in at least one direction. In addition, an “adjustment unit” in this context is intended to mean, in particular, a unit, with the aid of which at least one shielding parameter of the at least one shielding unit may be directly or indirectly changed. A change of the at least one shielding parameter may be triggered automatically by the adjustment unit and/or by a control of the induction charging device and manually by an operator. The adjustment unit may include control electronics. “Control electronics” in this case are intended to mean, in particular, a unit having a processor unit and a memory unit, as well as an operating program stored in the memory unit.

In principle, however, it would also be conceivable for the adjustment unit to merely include electronic circuitry. A “shielding parameter” in this context is intended to mean, in particular, a parameter of the shielding unit. A shielding parameter may be intended to mean, in particular, a shielding effect-influencing parameter of the shielding unit. A shielding parameter may be intended to mean a parameter of a magnetic field generated by the shielding unit during a shielding. Particularly, a shielding parameter may be intended to mean, in particular, a magnetic field strength of the magnetic field generated by the shielding unit during a shielding. In principle, however, other shielding parameters, which appear meaningful to those skilled in the art, are also conceivable, which in particular, influence a shielding effect of the shielding unit. “Provided” is intended to mean, in particular, specifically programmed, configured and/or equipped. An object being provided for a particular function is intended to mean, in particular, that the object fulfills and/or carries out this particular function in at least one application state and/or operating state.

With the design of the induction charging device according to the present invention, it is possible to achieve an advantageously adapted shielding. As a result, a shielding may be advantageously adapted to boundary conditions.

It is further provided that the at least one shielding unit includes at least one shielding element. The at least one shielding element may have an at least essentially circular design. The at least one shielding element may be formed by an aluminum ring. Because of the high conductivity of this material, the shielding element functions accordingly as a short-circuit ring, in particular, in at least one operating state. In one alternative embodiment, the shielding element may also have a disk-shaped design, whereby the shielding element may, in particular, have an essentially full-surface design. The basic shape of the shielding element is adapted, in particular, to the basic shape of the coil unit. To shield an essentially circular coil unit, the shielding element may also have a circular design. To shield a non-circular coil unit, which has, for example, an oval, rectangular or square design, the basic geometric shape of the shielding element is adapted to the basic shape of the coil unit and also has, for example, an oval, rectangular or square design. The shielding element is configured, in particular, to shield the coil unit from metallic objects during a charging operation of the induction rechargeable battery, in particular, from metallic objects located on a standing surface for the induction charging device, for example, a table surface. A standing surface made of a metallic material or metallic particles on the standing surface influence the function of the coil unit in a disadvantageous manner. In order to shield the induction coil from metallic objects on a standing surface for the induction charging device, the shielding element is situated, in particular, between a housing of the induction charging device and the coil unit. The shielding element in this case, in particular, faces one side of the coil unit, which faces away from a holding area for holding and/or storing an induction rechargeable battery. Accordingly, the shielding element is situated, in particular, on a side of the coil element, which faces a standing surface of the housing of the induction charging device. An advantageously adapted shielding, in particular, may be achieved in this way. As a result, a shielding may, in particular, be advantageously adapted to boundary conditions. In particular, a shielding may as a result be advantageously adapted to a base, in particular, to a material of the base.

It is also provided that the at least one shielding element includes at least one at least essentially radial slot, which interrupts the at least one shielding element in at least one operating state. The at least essentially radial slot may interrupt the shielding element at least essentially perpendicular to a circumferential direction. An “at least essentially radial slot” in this context is intended to mean, in particular, a slot, the extension direction of which runs at least essentially radially. An “at least essentially radial slot” may be intended to mean, in particular, that at least one essential directional component of the extension direction of the slot extends radially relative to the shielding element. “Radial” in this case is intended, in particular, to mean radial in relation to a center axis of the shielding element and/or extending perpendicularly toward the center axis. The center axis in this case is formed, in particular, by a surface normal of the main extension plane of the shielding element, which extends, in particular, through a geometric center point of the shielding element. A “main extension plane” of a structural unit is intended to mean, in particular, a plane, which is parallel to a largest lateral face of a smallest imaginary cuboid, which only just fully surrounds the structural unit, and which runs, in particular, through the center point of the cuboid. That “the slot interrupts the at least one shielding element” is intended in this context to mean, in particular, that the slot produces a gap in the shielding element material along a circumferential direction of the shielding element, at which the shielding element material is interrupted. An adapted shielding may, in particular, be advantageously achieved as a result of the at least essentially radial slot. An induction effect on the shielding element, in particular, may be changed by the slot.

It is further provided that the induction charging device includes at least one switch element, via which the at least one at least essentially radial slot may be electrically closed and/or opened. The at least essentially radial slot may be electrically bridged by the switch element. A bridging in this case may be achieved both by a mechanical closing of the slot as well as via a purely electronic bridging with the aid of the switch. A “switch element” in this context is intended, in particular, to mean an element, with the aid of which the at least one at least essentially radial slot may be electrically closed and/or opened. The switch element may include at least two states, whereby one state of the switch element may be changed, in particular, with the aid of an external control signal. The switch element may be provided for establishing and/or disconnecting an electrically conductive connection between two points, in particular, between the two sides of the slot. The switch element may include at least one control contact via which it may be switched. In this way, a shielding effect of the shielding element may be advantageously changed. A shielding effect may be particularly advantageously reduced by an opening of the slot. No induced, closed power circuit in the shielding element is able to form due to the opening of the slot, in particular, only isolated induced eddy currents form. As a result, only a very weak magnetic field may be generated by the shielding element. By closing the slot, an advantageously strong magnetic field may form. An advantageously strong shielding effect may be achieved in this way.

It is further provided that the adjustment unit is provided to open and/or close the at least one at least essentially radial slot as a function of an operating state in order to change the shielding parameter. The adjustment unit may activate the switch element to open and/or close the slot. In this way, the shielding parameter may be changed advantageously simply with the aid of the adjustment unit. In this way, a shielding effect, in particular, may be changed, advantageously simply with the aid of the adjustment unit. An alternating may take place, in particular, between two different states. As a result, a shielding may be advantageously simply adapted to boundary conditions.

It is further provided that the adjustment unit is provided to switch the shielding unit between a short-circuit mode and an idle mode in order to change the shielding parameter. The adjustment unit may be provided for switching between a short-circuit mode and an idle mode in order to activate the switch element. In a short-circuit mode, the at least one at least essentially radial slot is closed or bridged. In an idle mode, the at least one at least essentially radial slot is opened. A “short-circuit mode” in this context is intended to mean, in particular, a mode of the shielding unit, in which the shielding unit functions as a short-circuit ring. A short-circuit mode may be intended to mean, in particular, a mode, in which the shielding unit is provided for an advantageous shielding. In the short-circuit mode, the current induced in the shielding element may generate an electromagnetic force, which is phase-shifted compared to the electromagnetic force of the coil unit. A magnetic field of the shielding element formed in this way cancels out at least partially an effect of the magnetic field of the coil unit in the direction in which the shielding element is situated. In an ideal configuration, no magnetic flux is able to occur in this direction, so that the magnetic fields cancel one another out. Thus, during the short-circuit mode, a magnetic field of the coil unit is “bent away” from the bottom of the induction charging device. Thus, the influence of various materials as a support for the induction charging device is at least reduced. The “bending” of the magnetic field of the coil unit is associated with an increase of the magnetic resistance. This results in a reduced inductance of the coil unit and in an increased resonance frequency of a primary oscillator circuit.

An “idle mode” in this context is intended to mean, in particular, a mode of the shielding unit in which a shielding effect is significantly reduced. In the idle mode, the current induced in the shielding element may generate only isolated eddy currents. A magnetic field of the shielding unit formed in this way is too weak to significantly reduce an effect of the magnetic field of the coil unit in the direction in which the shielding unit is situated. The reduced shielding is associated with a reduced magnetic resistance as compared to the short-circuit mode. This results in a higher inductance of the coil unit and a reduced resonance frequency of the primary oscillator circuit. In this way, a shielding effect, in particular, may be changed advantageously simply with the aid of the adjustment unit. An alternating may take place, in particular, between two different modes. As a result, a shielding may be advantageously simply adapted to boundary conditions. Furthermore, the resonance frequency of the oscillator circuit may be changed as a result, without influencing the actual frequency-determining components of the coil unit.

It is further provided that the induction charging device includes at least one control unit, with the aid of which a manual switching between a short-circuit mode and an idle mode may take place. The control unit may be connected to the adjustment unit. A “control unit” is intended here to mean, in particular, a unit which includes at least one control element, which is directly actuatable by an operator and which is provided to influence and/or to alter a process and/or a state of a unit coupled to the control unit by an actuation and/or an input of parameters. A “control element” is intended here to mean, in particular, an element, which is provided to receive an input variable from an operator during a control operation and, in particular, to be directly contacted by an operator, a touching of the control element being sensed and/or an actuation force applied to the control element being sensed and/or being mechanically transmitted in order to actuate a unit. In this way, a manual switching between the modes of the shielding unit, in particular, may be achieved. As a result, this could, for example, enable an operator to indicate manually whether the induction charging device is standing on a non-magnetic base, on a ferromagnetic base and/or on a diamagnetic or paramagnetic base. This could, for example, enable an advantageously efficient charging operation on a base made of a non-magnetic material such as, for example, wood or plastic. An advantageous shielding may, however, also be enabled on a different base.

It is further provided that the adjustment unit is provided to change a resonance frequency of an oscillator circuit of the coil unit by changing a shielding parameter of the at least one shielding unit. For this purpose, the adjustment unit may be connected, in particular, to an electronics unit of the induction charging device, which is provided for controlling and/or regulating a charging operation. In principle, the adjustment unit may particularly also be configured integrally into the electronics unit. In this way, the resonance frequency of the primary oscillator circuit of the coil unit may, in particular, be changed without influencing the actual frequency-determining components of the coil unit.

The present invention is also directed to a method for operating the induction charging device. It is provided that the adjustment unit opens the at least one at least essentially radial slot of the at least one shielding element to lower a resonance frequency of an oscillator circuit and/or closes it to increase a shielding of the coil unit. As a result, the induction charging device may be advantageously adapted. A shielding effect, in particular, may be changed, simply with the aid of the adjustment unit. An alternating may take place, in particular, between two different states. As a result, a shielding may be advantageously simply adapted to boundary conditions. Furthermore, it is possible in this way to modify the resonance frequency of the oscillator circuit without influencing the actual frequency-determining components of the coil unit.

The induction charging device according to the present invention and the method according to the present invention are not to be limited to the application and specific embodiment described above. The induction charging device according to the present invention and the method according to the present invention may include, in particular, one of a number of individual elements, components and units cited herein for executing a functionality described herein.

Additional advantages result from the following drawing description. An exemplary embodiment of the present invention is depicted in the drawing. The drawing, the description and the claims include numerous features in combination. Those skilled in the art will advantageously also consider the features individually and combine them to form meaningful additional combinations.

### BRIEF DESCRIPTION OF THE DRAWINGS

FIG. 1 shows a system, including an induction charging device according to the present invention and including an induction rechargeable battery in a schematic, perspective view.

FIG. 2 shows the induction charging device according to the present invention, including a coil unit and including a shielding unit in a schematic exploded view.

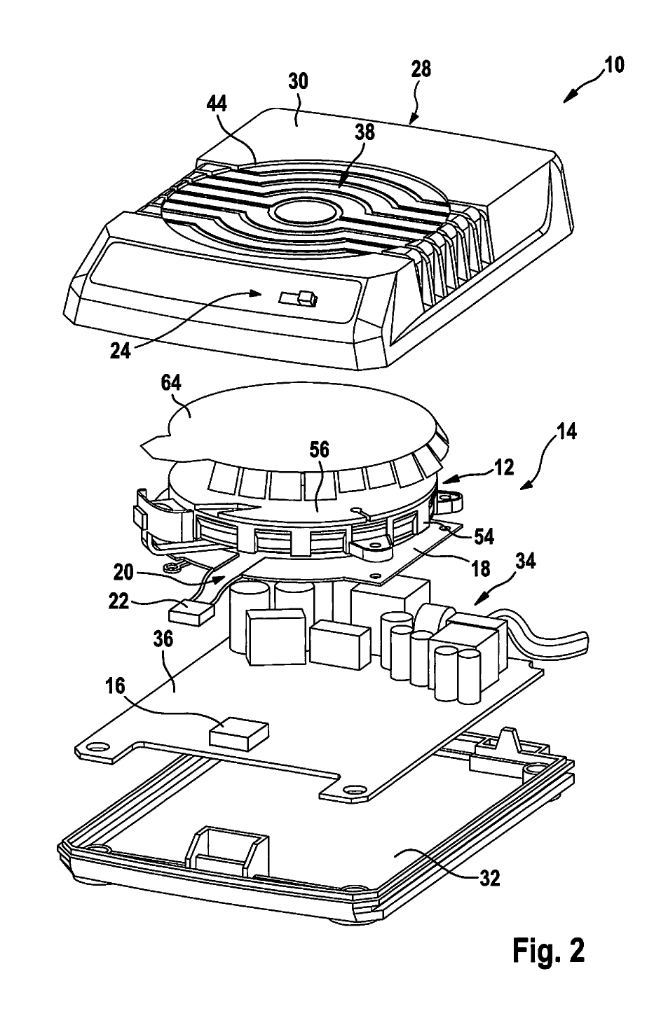

FIG. 3 shows the induction charging device according to the present invention, including an opened exterior housing in a schematic view from below.

FIG. 4 shows the coil unit of the induction charging device according to the present invention in a schematic exploded view.

FIG. 5 schematically shows a flow chart of a method for operating the induction charging device according to the present invention.

### DETAILED DESCRIPTION

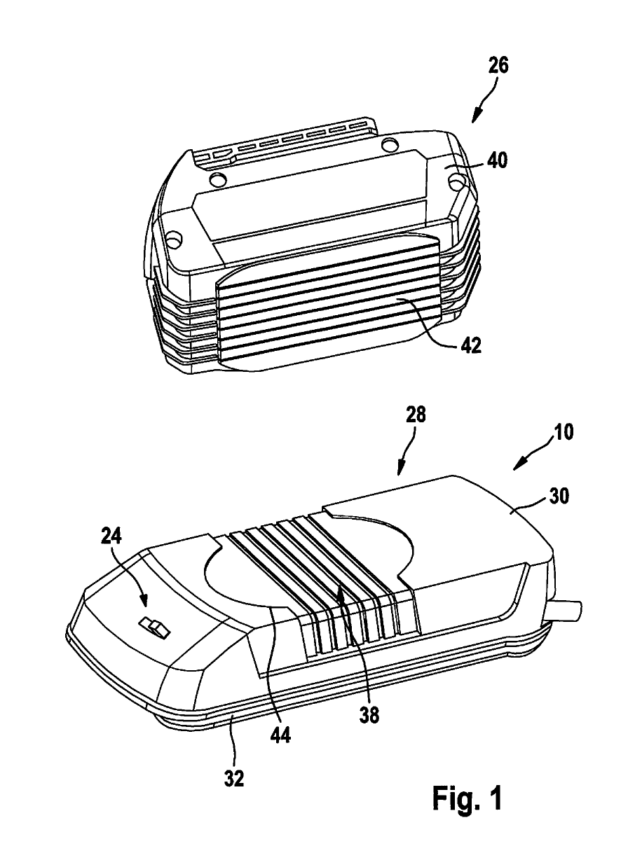

FIG. 1 depicts a system, including an induction charging device 10 and including an induction rechargeable battery 26. Induction charging device 10 is provided to electrically charge induction rechargeable battery 26 in a charge state. Induction rechargeable battery 26 is configured as a hand-held power tool induction rechargeable battery. Induction rechargeable battery 26 is configured to be inductively chargeable with the aid of induction charging device 10. Induction rechargeable battery 26 is configured to be coupleable with induction charging device 10. Induction charging device 10 is provided for transferring an energy to induction rechargeable battery 26 in a state coupled with induction rechargeable battery 26. Induction charging device 10 is configured as a hand-held power tool induction charging device. Induction charging device 10 is configured as an induction charging unit. Induction charging device 10 includes a coil unit 12. Induction charging device 10 also includes an exterior housing 28. Exterior housing 28 surrounds coil unit 12. Exterior housing 28 includes two housing shells 30, 32. Exterior housing 28 includes an upper housing shell 30 and a lower housing shell 32 which, not further visible, are screwed together. In principle, however, a detent connection and/or an adhesive bond between housing shells 30, 32 would also be conceivable. Coil unit 12 is provided for inductively transferring energy to induction rechargeable battery 26 in a charge state. Induction charging device 10 includes an electronics unit 34, which is provided to control or regulate a charging operation. Electronics unit 34 includes at least one circuit board 36 fitted with electronic components. Circuit board 36 includes a copper coating on a side facing away from coil unit 12 of induction charging device 10. In addition, circuit board 36 of electronics unit 34 includes an SMD assembly on a side facing away from coil unit 12 of induction charging device 10.

Exterior housing 28 of induction charging device 10 includes a holding area 38, which is provided for holding induction rechargeable battery 26 in a coupled state. Induction rechargeable battery 26 also includes a housing 40, which includes a positioning element 42 for coupling induction rechargeable battery 26 to holding area 38 of exterior housing 28 of induction charging device 10 in a coupled state.

Positioning element 42 of induction rechargeable battery 26 is configured as a platform, which rises above an outer surface of adjoining housing 40 of induction rechargeable battery 26. Holding area 38 of exterior housing 28 of induction charging device 10 includes at least one recess. The recess forms a positioning element 44 for positioning induction rechargeable battery 26. It is also conceivable, however, that positioning element 44 of induction charging device 10 is configured as a platform and positioning element 42 of induction rechargeable battery 26 is configured as a recess. The recess has a step height of at least 0.5 mm. Positioning element 42 of induction rechargeable battery 26 has a step height of at least 0.5 mm. Positioning element 44 of induction charging device 10 and positioning element 42 of induction rechargeable battery 26 are correspondingly configured.

Positioning element 44 of induction charging device 10 and positioning element 42 of induction rechargeable battery 26 each have a step height of 3 mm. Other dimensions, which appear meaningful to those skilled in the art, are also conceivable, however. Positioning element 44 of induction charging device 10 has a partially curved outer contour. The outer contour of positioning element 44 of induction charging device 10 is rounded. Positioning element 42 of induction rechargeable battery 26 has a partially curved outer contour. The outer contour of positioning element 42 of induction rechargeable battery 26 is square with rounded corners. A diameter of positioning element 44 of induction charging device 10 corresponds at least virtually to a diagonal length of positioning element 42 of induction rechargeable battery 26. A minimal tolerance is provided between the dimensions of positioning element 44 of induction charging device 10 and of positioning element 42 of induction rechargeable battery 26. Alternatively, it is also conceivable that the outer contour of positioning element 44 of induction charging device 10 is square with rounded corners and the outer contour of positioning element 42 of induction rechargeable battery 26 is round. It is further conceivable that the outer contour of positioning element 44 of induction charging device 10 or of positioning element 42 of induction rechargeable battery 26 has another geometric shape, which appears meaningful to those skilled in the art, in particular, with rounded corners. In a charge state, induction rechargeable battery 26 rests on induction charging device 10, so that positioning element 42 of induction rechargeable battery 26 engages in positioning element 44 of induction charging device 10. In the process, housing 40 of induction rechargeable battery 26 directly contacts exterior housing 28 of induction charging device 10.

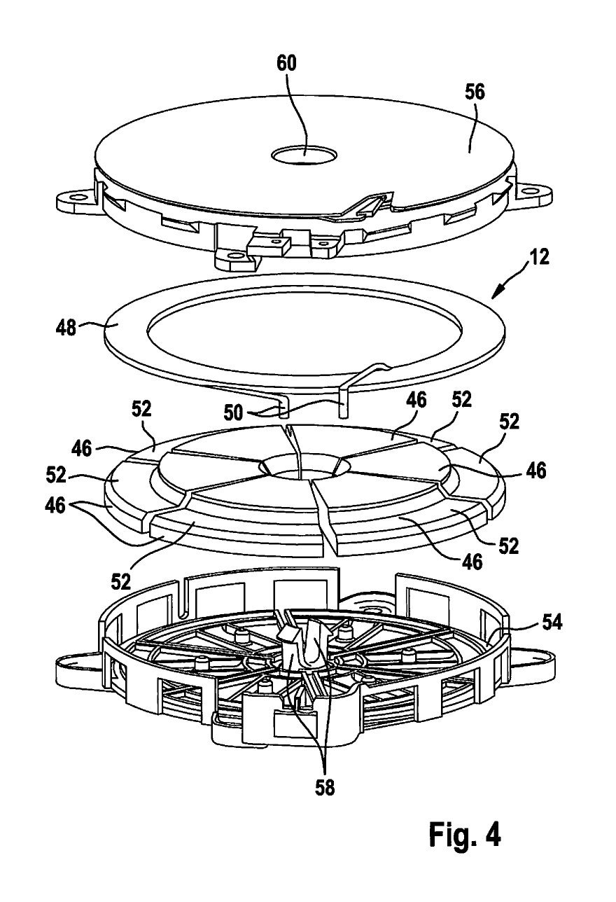

Induction charging device 10 includes coil unit 12, which is provided to transfer energy in a state coupled to an induction rechargeable battery 26. Electrical energy is transferred in the coupled state from induction charging device 10 to induction rechargeable battery 26 with the aid of coil unit 12. Coil unit 12 includes at least one core element 46 and at least one induction coil 48, which at least partially surrounds the at least one core element 46 (FIG. 4). Coil unit 12 includes six identically shaped core elements 46 and one induction coil 48, which surrounds core elements 46 in the circumferential direction. Induction coil 48 includes multiple windings situated one on top of the other. Induction coil 48 includes two coil connections 50, which are configured spaced apart from one another. Induction coil 48 has a round contour. Induction coil 48 has a circular basic shape. Induction coil 48 may alternatively also have a non-circular, for example, oval, rectangular or square basic shape. Core elements 46 each have a partially circular design. In a mounted state, core elements 46 are situated next to one another in such a way that the six core elements 46 together form a circular contour. Core elements 46 are provided to partially inductively shield electronics unit 34 of induction charging device 10. Core elements 46 are provided for increasing an inductance of the at least one induction coil 48. Core elements 46 are formed from a metal. Core elements 46 are configured as ferrite cores.

Core elements 46 each have a protrusion 52 on a side facing away from holding area 38. Induction coil 48 encompasses core elements 46 in a mounted state in the circumferential direction.

Protrusion 52 of core elements 46 has a larger diameter than a winding diameter of induction coil 48. Induction coil 48 is situated in a mounted state between protrusions 52 of core elements 46 and holding area 38 of induction charging device 10 in the axial direction, which runs perpendicular to the diameter of the windings of induction coil 48. The side of core element 46 facing away from induction coil 48 is formed by an essentially planar surface.

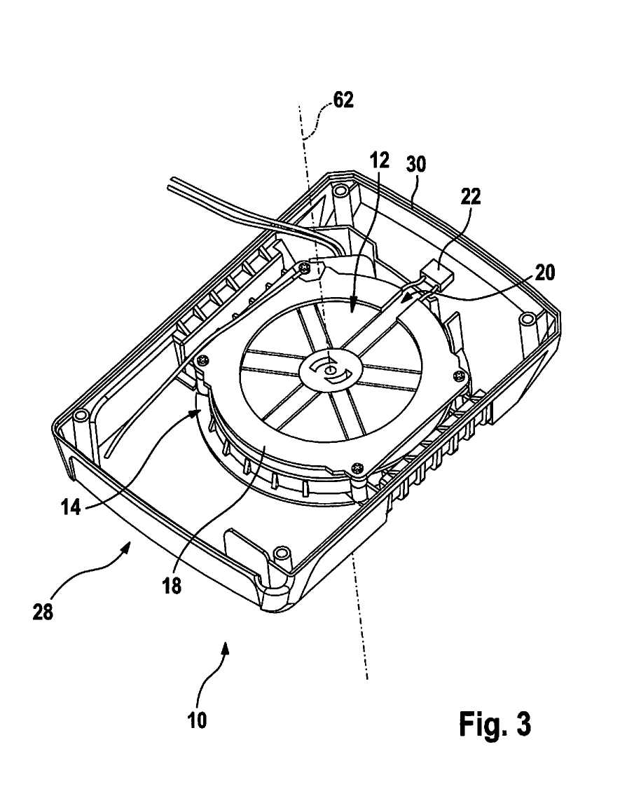

Induction charging device 10 further includes a coil housing unit, which surrounds coil unit 12. The coil housing unit includes two coil housing elements 54, 56 which, in the mounted state, are coupled to one another via a detent element 58. The coil housing unit has a largely cylindrically shaped outer contour. A first coil housing element of coil housing elements 54 has two detent elements 58 (FIG. 3). Detent elements 58 are permanently connected to first coil housing element 54. Detent elements 58 and first coil housing element 54 are configured as a single piece. Detent elements 58 are formed by snap hooks. Detent elements 58 are situated in a center of first coil housing element 54. Detent elements 58 are configured to be resiliently deflectable in the radial direction of first coil housing element 54. Another coil housing element of coil housing elements 56 is provided to hold induction coil 48. Additional coil housing element 56 is also provided to hold core elements 46 in a mounted state. Additional coil housing element 56 is configured as a coil carrier. Core elements 46 and induction coil 48 of coil unit 12 in a mounted state are at least virtually completely enclosed in additional coil housing element 56 configured as a coil carrier. Additional coil housing element 56 further includes a detent recess 60, which is configured to correspond to detent elements 58 of first coil housing element 54. Detent recess 60 is situated in a center of additional coil housing element 56. In a mounted state, detent elements 58 of first coil housing element 54 reach through detent recess 60 of additional coil housing element 56 and are locked in place with the additional coil housing element. Thus, in the mounted state, coil housing elements 54, 56 are connected to one another in a form-locked manner.

Induction charging device 10 further includes a shielding unit 14. Shielding unit 14 is provided to partially shield coil unit 12. Shielding unit 14 is provided to reduce electromagnetic disturbances. Shielding unit 14 includes a shielding element 18. For the function of shielding element 18, it is important that shielding element 18 be situated in induction charging device 10 between coil unit 12 and exterior housing 28, in particular, between coil unit 12 and second housing shell 32. In this configuration, one side of shielding element 18 faces second housing shell 32, whereas the other opposite side of shielding element 18 faces coil unit 12. Thus, during a charging operation of an induction rechargeable battery 26 with induction charging device 10, shielding element 18 is situated between coil unit 12 and second housing shell 32. During the charging operation, second housing shell 32 forms a standing surface for induction charging device 10, for example, a table surface. Shielding element 18 is situated between coil housing element 56 and second housing shell 32. In an alternative specific embodiment not depicted, shielding element 18 may also form an element of coil unit 12. In this case, shielding element 18 may be situated in coil housing element 56. In this case, shielding element 18 may be situated, in particular, between coil housing element 56 and core elements 46.

In the depicted specific embodiment, shielding element 18 is detachably fastened in induction charging device 10 with the aid of fastening elements in the form of screws. The fastening elements interact with the retaining elements of upper housing shell 30. In this way, shielding element 18 is detachably fastened to upper housing shell 30. One of the fastening elements also assumes the function of establishing an electrically conductive connection between shielding element 18 and an electric line in the form of a cable. Shielding element 18 is connected via the electric line to a ground. Shielding element 18 is formed from an electrically conductive material. It is advantageously formed from a metallic material. Shielding element 18 is made of aluminum. Shielding element 18 is configured to shield coil unit 12 from metallic objects located on a standing surface for induction charging device 10, for example, on a table surface. A standing surface made of a metallic material or metallic particles on the standing surface influence the function of coil unit 12 in a disadvantageous manner. Shielding element 18 has an essentially ring-shaped design. Shielding element 18 is formed by an aluminum ring. In one alternative specific embodiment not depicted, shielding element 18 may also have a disk-shaped design. Shielding element 18 in this case may have, in particular, a full-surface design. To achieve a sufficient mechanical stability, shielding element 18 has a thickness, for example, of approximately 1 mm, however, shielding element 18 may also have a significantly smaller thickness.

It is advantageous for the function of shielding element 18 if shielding element 18 has what may be a large surface expansion relative to the surface encompassed by induction coil 48.

Shielding element 18 has a surface expansion, which corresponds at least essentially to the surface formed by induction coil 48. The essentially circular shielding element 18 has an outer diameter, which is at least as large as the outer diameter of induction coil 48. In one alternative specific embodiment, in which induction coil 48 is not ring-shaped, but rather is, for example, oval, rectangular or square, the geometric basic shape of shielding element 18 is advantageously adapted to the basic shape of induction coil 48. In this case, a projection surface of shielding element 18 formed in a projection of shielding element 18 along the axial direction is at least approximately as large as the projection surface of induction coil 48, which in a projection of induction coil 48 is formed along the axial direction.

Shielding element 18 includes a radial slot 20. Slot 20 extends perpendicular to a center axis 62 of shielding element 18. A direction of extension of slot 20 intersects center axis 62. Center axis 62 in this case is formed by a surface normal of a main extension plane of shielding element 18, which extends through a geometric center point of shielding element 18. In principle, however, another extension of slot 20, which appears meaningful to those skilled in the art, would also be conceivable. Slot 20 interrupts shielding element 18 in at least one operating state. Slot 20 forms a gap in shielding element 18, in which there is a void in the material of shielding element 18.

Shielding unit 14 further includes an additional shielding element 64. Additional shielding element 64 is situated in induction charging device 10 between coil unit 12 and holding area 38. In this configuration, one side of additional shielding element 64 faces holding area 38, whereas the other opposite side of additional shielding unit 64 faces induction coil 48. Thus, during a charging operation of induction rechargeable battery 26 with induction charging device 10, additional shielding element 64 is situated between induction coil 48 and induction rechargeable battery 26 or between induction coil 48 and an induction coil 48 of induction rechargeable battery 26. Additional shielding element 64 is configured to form a bypass capacitor with induction coil 48 of induction charging device 10. Induction coil 48 in this case forms a first electrode of the bypass capacitor and additional shielding element 64 forms a second electrode of the bypass capacitor.

Induction charging device 10 further includes a switch element 22. With switch element 22, it is possible to electrically close and/or open radial slot 20 of shielding element 18. Radial slot 20 may be electrically bridged by switch element 22. Switch element 22 has two states, whereby one state of switch element 22 may be altered with the aid of an external control signal. For this purpose, switch element 22 includes a control contact not otherwise visible, via which it may be switched. Switch element 22 is provided to establish and/or disconnect an electrically conductive connection between two sides of slot 20 of shielding element 18. Switch element 22 is formed by an electrical switch. In principle, however, it would also be conceivable that switch element 22 is formed by a mechanical switch element. In this case, it would be conceivable, in particular, that switch element 22 includes an element made of a conductive material, in particular, aluminum, the size of which corresponds at least essentially to a size of slot 20, and which may be moved via a mechanism into or out of slot 20. In this way, slot 20 could be, in particular, temporarily closed or opened.

Thus, a bridging could be achieved both by a mechanical closing of slot 20 as well as via a purely electronic bridging of slot 20.

In addition, induction charging device 10 includes an adjustment unit 16. A shielding parameter of shielding unit 14 is changeable with the aid of adjustment unit 16. Adjustment unit 16 is connected to electronics unit 34 of induction charging device 10. Adjustment unit 16 forms a part of electronics unit 34. Adjustment unit 16 is provided to open or to close radial slot 20 as a function of an operating state in order to change the shielding parameter. For this purpose, adjustment unit 16 is connected to switch element 22. Adjustment unit 16 is provided to activate switch 22. A shielding parameter of shielding unit 14 may be changed by an opening or closing of slot 20. For this purpose, adjustment unit 16 is provided to switch shielding unit 14 between a short-circuit mode and an idle mode for changing the shielding parameter.

Adjustment unit 16 is provided for switching between a short-circuit mode and an idle mode in order to activate switch element 22. In a short-circuit mode, radial slot 20 of shielding element 18 is closed or bridged. In an idle mode, radial slot 20 of shielding element 18 is opened. In the short-circuit mode of shielding unit 14, shielding element 18 functions as a short-circuit ring. Shielding element 18 provides an advantageous shielding in the short-circuit mode. In the short circuit mode, the current induced into shielding element 18 generates an electromagnetic force, which is phase-shifted as compared to that of coil unit 12. A magnetic field of shielding element 18 formed in this way partially cancels out an effect of the magnetic field of coil unit 12 in the direction in which shielding element 18 is situated. Thus, a magnetic field of coil unit 12 is “bent away” from the bottom of induction charging device 10 during the short-circuit mode. This reduces the influence of various materials as a support for induction charging device 10. The “bending” of the magnetic field of coil unit 12 is associated with an increase of the magnetic resistance. This results in a reduced inductance of coil unit 12 and an increased resonance frequency of a primary oscillator circuit. In the idle mode, on the other hand, a shielding effect of shielding element 18 is significantly reduced. Because of slot 20 in shielding element 18, an induced current generates only isolated eddy currents. A magnetic field of shielding element 18 formed in this way is too weak to significantly reduce an effect of the magnetic field of coil unit 12 in the direction in which the shielding element 18 is situated. The reduced shielding is associated with a reduced magnetic resistance as compared to the short-circuit mode. This results in a higher inductance of coil unit 12 and a reduced resonance frequency of the primary oscillator circuit.

Adjustment unit 16 is provided to change a resonance frequency of an oscillator circuit of coil unit 12 by changing the shielding parameter of shielding unit 14. By switching between the short-circuit mode and the idle mode, it is possible to adapt the resonance frequency of the primary oscillator circuit of coil unit 12. In this way, the resonance frequency may be regulated by adjustment unit 16 to an optimal value. Adjustment unit 16 is activated for this purpose via electronics unit 34 of induction charging device 10.

Induction charging device 10 further includes a control unit 24. With the aid of control unit 24, it is possible to manually switch between a short-circuit mode and an idle mode. With the aid of control unit 24, an operator may manually switch between a short-circuit mode and an idle mode. For this purpose, control unit 24 is connected to adjustment unit 16. This could, for example, enable an operator to indicate manually whether induction charging device 10 is standing on a non-magnetic base on a ferromagnetic base and/or on a diamagnetic or paramagnetic base, in order to enable an advantageously efficient charging operation. Control unit 24 is formed by a slide switch. Control unit 24 has three positions. A first position of control unit 24 defines a short-circuit mode, a second position of control unit 24 defines an idle mode and a third position of control unit 24 defines an automatic mode. In the automatic mode, a switching by adjustment unit 16 takes place automatically between the short-circuit mode and the idle mode.

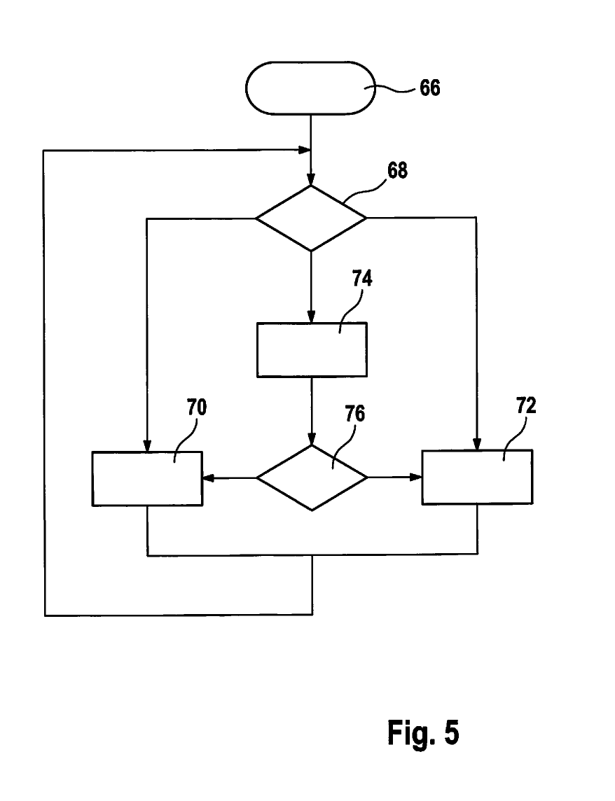

FIG. 5 schematically shows a flow chart of a method for operating induction charging device 10. In the method, adjustment unit 16 opens radial slot 10 of shielding element 18 in order to lower a resonance frequency of an oscillator circuit of coil unit 12, or closes radial slot 20 of shielding element 18 in order to increase a shielding of coil unit 12. During the operation of induction charging device 10, a position of control unit 24 is checked after a start 66 in a first branch 68. If control unit 24 is in a first position, radial slot 20 of shielding element 18 is closed or remains closed in a further method step 70. If control element 24 is in a second position, radial slot 20 of shielding element 18 is opened or remains open in a further method step 72. If control unit 24 is in a third position, a magnetism of a base of induction charging device 10 is sensed in a further method step 74. This may occur, for example, via a separate sensor such as, for example, a magnetic sensor. In principle, however, it would also be conceivable to sense the magnetism by monitoring the oscillator circuit of coil unit 12 during a switch between the short-circuit mode and the idle mode. The sensed values are subsequently evaluated in a branch 76. If the base is made of a non-magnetic material such as, for example, wood or plastic, radial slot 20 of shielding element 18 is opened or remains open in a further method step 72. If the base is made of a ferromagnetic material or diamagnetic material such as, for example, iron, nickel, copper or aluminum, radial slot 20 of shielding element 18 is closed or remains closed in a further method step 70. After method steps 70 and 72, the method is then repeated at branch 68 until induction charging device 10 is deactivated.

What is claimed is:

1. An induction charging device, comprising:
a coil unit;
at least one shielding unit for at least partially shielding the coil unit; and
at least one adjustment unit to change a shielding parameter of at least one shielding unit.

2. The induction charging device of claim 1, wherein the at least one shielding unit includes at least one shielding element.

3. The induction charging device of claim 2, wherein the at least one shielding element includes at least one at least essentially radial slot, which interrupts the at least one shielding element in at least one operating state.

4. The induction charging device of claim 3, further comprising:
at least one switch element, via which the at least one at least essentially radial slot can be electrically closed and/or opened.

5. The induction charging device of claim 3, wherein the adjustment unit is configured to open and/or to close the at least one at least essentially radial slot as a function of an operating state in order to change the shielding parameter.

6. The induction charging device of claim 1, wherein the adjustment unit is configured to switch the shielding unit between a short-circuit mode and an idle mode to change the shielding parameter.

7. The induction charging device of claim 6, further comprising:
at least one control unit, with which a switching is able to take place between a short-circuit mode and an idle mode.

8. The induction charging device of claim 1, wherein the adjustment unit is configured to change a resonance frequency of an oscillator circuit of the coil unit by changing a shielding parameter of the at least one shielding unit.

9. A method for operating an induction charging device, the method comprising:
performing at least one of the following:
opening, via an adjustment unit of the induction charging device, at least one at least essentially radial slot of at least one shielding element to lower a resonance frequency of an oscillator circuit of a coil unit; and
closing, via the adjustment unit, the at least one at least essentially radial slot of the at least one shielding element to increase a shielding of the coil unit;
wherein the induction charging device includes the coil unit, the at least one shielding unit for at least partially shielding the coil unit, and the at least one adjustment unit to change the shielding parameter of the at least one shielding unit.

10. The method of claim 9, wherein the induction charging device includes a hand-held power tool induction charging device.

11. The induction charging device of claim 1, wherein the induction charging device includes a hand-held power tool induction charging device.
